(19) United States
(12) Patent Application Publication
(10) Pub. No.: US 2011/0115290 A1
(43) Pub. Date: May 19, 2011

(54) ELECTRIC VEHICLE CONTROL APPARATUS

(75) Inventors: Ayako Tanabe, Tokyo (JP); Mitsuhiro Numazaki, Tokyo (JP)

(73) Assignee: Kabushiki Kaisha Toshiba, Tokyo (JP)

(21) Appl. No.: 12/992,220

(22) PCT Filed: May 11, 2009
(86) PCT No.: PCT/JP09/02052

§ 371 Date: Feb. 3, 2011

(30) Foreign Application Priority Data
May 12, 2008 (JP) 2008-124845

(51) Int. Cl. B60L 1/00

(52) U.S. Cl. 307/10.1

(57) ABSTRACT

An electric vehicle control apparatus includes: a main power source (1) to (3) that supplies DC power; a power conversion device (8) that converts the DC power from the main power source to AC power, which it then supplies to a vehicle drive motor (9); an electric storage device (7) for accumulating DC power arranged in parallel between the main power source and power conversion device; a chopper device (5) that is connected in series with the electric storage device, and that supplies power to the electric storage device by chopping the DC power from the main power source and the regenerated DC power from the power conversion device; and a freewheeling diode (6) for passing current in a direction such as to supply current from the electric storage device to the power conversion device, connected in series with the electric storage device and in parallel with the chopper device.

### TECHNICAL FIELD

The present invention relates to an electric vehicle control apparatus comprising an electric storage device that performs the action of absorbing regenerated braking energy and a power conversion device that controls a vehicle drive motor.

### TECHNICAL BACKGROUND

A conventional electric vehicle control apparatus comprising an accumulation device that performs the action of absorbing regenerated braking energy and a power conversion device that controls a vehicle drive motor has a construction as shown in FIG. 1. In this construction, an internal combustion engine 1 drives a generator 2 that supplies power to a power conversion device 8 through a rectifier 3 and/or filter reactor 4. AC power converted by this power conversion device 8 drives the motor 9. In addition, as a storage circuit, there is provided an electric storage device 7 such as an electrical double layer capacitor (or electric double layer capacitor) and there are provided voltage boosting chopper devices (or voltage boosting/stepping down chopper devices) 12, and freewheeling diodes 6 that perform a rectifying action. The electric storage device 7 performs charging/discharging of power supplied from the rectifier 3.

In such a prior art electric vehicle control apparatus, voltage adjustment cannot be performed without employing voltage boosting chopper devices 12, so simplification of the circuitry presented a difficult problem. A further problem was that, if element malfunction or the like of the power conversion device 8 occurred, causing short-circuiting in the power conversion device 8, consequential damage could arise due to inflow or discharge of fault current in respect of the electric storage device 7, which accumulates a large amount of energy. Yet a further problem was that the vehicle became inoperable in the event of short-circuiting of the electric storage device 7.

Also, an electrical vehicle drive system in which an electric storage device is mounted as shown in for example Laid-open Japanese Patent Application Number Tokkai 2005-176528 (hereinafter referred to as Patent Reference 1) is known. In this prior art electrical vehicle drive system, if the power conversion device fails, further damage to the power conversion device can be prevented by cutting off the fault current from the electric storage device to the power conversion device.

Furthermore, in the case of an electric vehicle drive system incorporating an electric storage device and an auxiliary power device, damage to the auxiliary power source device can be prevented by cutting off the fault current from the electric storage device to the auxiliary power source device when short-circuiting occurs in the electric storage device. Also, operation of the vehicle can be continued in the event of a fault of the electric storage device by using a current cut-off device to open-circuit the electric storage device and supplying DC power from the main power source directly to the auxiliary power source.

### DISCLOSURE OF THE INVENTION

The present invention was made in the light of the above problems of the prior art, an object being to provide an electric vehicle control apparatus in which the storage circuitry in respect of a conventional electric vehicle control apparatus comprising a storage circuit constituted by for example an electric storage device and/or voltage boosting chopper devices and freewheeling diodes can be simplified by adopting a construction of the storage circuit whereby voltage regulation can be achieved without employing a voltage boosting chopper.

A further object of the present invention is to provide an electric vehicle control apparatus in which consequential damage caused by fault current can be prevented.

Yet a further object of the present invention is to provide an electric vehicle control apparatus in which, even in a condition in which a fault of the power conversion device has occurred, consequential damage to the electric storage device can be prevented and charging in the electric storage device can be continued through the freewheeling diode, and operation of the vehicle can be continued by supply of driving power (or running power) from the generator.

In order to achieve the above objects, an electric vehicle control apparatus according to the present invention is constructed as follows. Specifically, a first aspect of the present invention consists in:

an electric vehicle control apparatus comprising:

a power source that supplies DC power;

a power conversion device that converts the DC power from aforementioned power source to AC power, which it then supplies to a vehicle drive motor;

an electric storage device for accumulating DC power arranged in parallel between aforementioned power source and power conversion device;

a chopper device that is connected in series with aforementioned electric storage device, and that supplies power to aforementioned electric storage device by chopping the DC power from aforementioned power source and the regenerated DC power from aforementioned power conversion device; and

a freewheeling diode for passing current in a direction such as to supply current from aforementioned electric storage device to aforementioned power conversion device, connected in series with aforementioned electric storage device and in parallel with aforementioned chopper device.

Another aspect of the present invention consists in:

an electric vehicle control apparatus comprising:

a power source that supplies DC power;

a power conversion device that converts the DC power from aforementioned power source to AC power, which it then supplies to a vehicle drive motor;

an electric storage device for accumulating DC power arranged in parallel between aforementioned power source and power conversion device;

a freewheeling diode for passing current in a direction such as to supply current from aforementioned power source to aforementioned electric storage device, connected in series with aforementioned electric storage device; and

a current cut-off device comprising a switch or contacts connected in series with aforementioned electric storage device and connected in parallel with aforementioned freewheeling diode.

Yet another aspect of the present invention consists in:

an electric vehicle control apparatus comprising:

a power source that supplies DC power;

a power conversion device that converts the DC power from aforementioned power source to AC power, which it then supplies to a vehicle drive motor;

an electric storage device for accumulating DC power arranged in parallel between aforementioned power source and power conversion device;

a freewheeling diode for passing current in a direction such as to supply current from aforementioned power source to aforementioned electric storage device, connected in series with aforementioned electric storage device; and

a current cut-off device comprising a fuse connected in series with aforementioned electric storage device and connected in parallel with aforementioned freewheeling diode.

### BRIEF DESCRIPTION OF THE DRAWINGS

FIG. 1 is a block diagram showing the construction of an electric vehicle control apparatus according to a first embodiment of the present invention;

FIG. 2 is a block diagram showing the construction of an electric vehicle control apparatus according to a second embodiment of the present invention;

FIG. 3 is a block diagram showing the construction of an electric vehicle control apparatus according to a third embodiment of the present invention;

FIG. 4 is a block diagram showing the construction of an electric vehicle control apparatus according to a fourth embodiment of the present invention;

FIG. 5 is a block diagram showing the construction of an electric vehicle control apparatus according to a fifth embodiment of the present invention; and

FIG. 6 is a block diagram showing the construction of a conventional electric vehicle control apparatus.

### BEST MEANS FOR PUTTING THE INVENTION INTO PRACTICE

Embodiments of the present invention are described in detail below with reference to the drawings. It should be noted that repeated description is avoided by attaching the same reference symbols to identical or corresponding parts in the following drawings.

### First Embodiment

FIG. 2 shows the construction of an electric vehicle control apparatus according to a first embodiment of the present invention.

In the circuit layout of the electric vehicle control apparatus of this embodiment, an internal combustion engine 1 drives a generator 2 that supplies power to a power conversion device 8 through a rectifier 3 and/or filter reactor 4, and a motor 9 is driven by AC produced by the conversion by this power conversion device 8. An electric storage device 7 such as an electrical double layer capacitor, and a chopper device 5 for charging/discharging of this electric storage device 7 and a freewheel diode 6 that performs rectifying action are provided.

When regenerative braking of the motor 9 is performed, regenerated energy from the power conversion device 8 is accumulated by the electric storage device 7, through the chopper device 5. Also, the regenerated energy is blocked by the rectifier 3, so that it cannot flow to the power source side of the generator 2.

When the motor 9 is performing drive, if the engine speed of the internal combustion engine 1 is low, the output voltage of the rectifier 3 is low; if this voltage is lower than the voltage of the electric storage device 7, the driving energy accumulated by the electric storage device 7 is supplied to the power conversion device 8 through the freewheeling diode 6.

When the engine speed of the internal combustion engine 1 becomes higher and the output voltage of the rectifier 3 becomes high, the power supply from the electric storage device 7 to the power conversion device 8 is automatically changed over to supply from the generator 2.

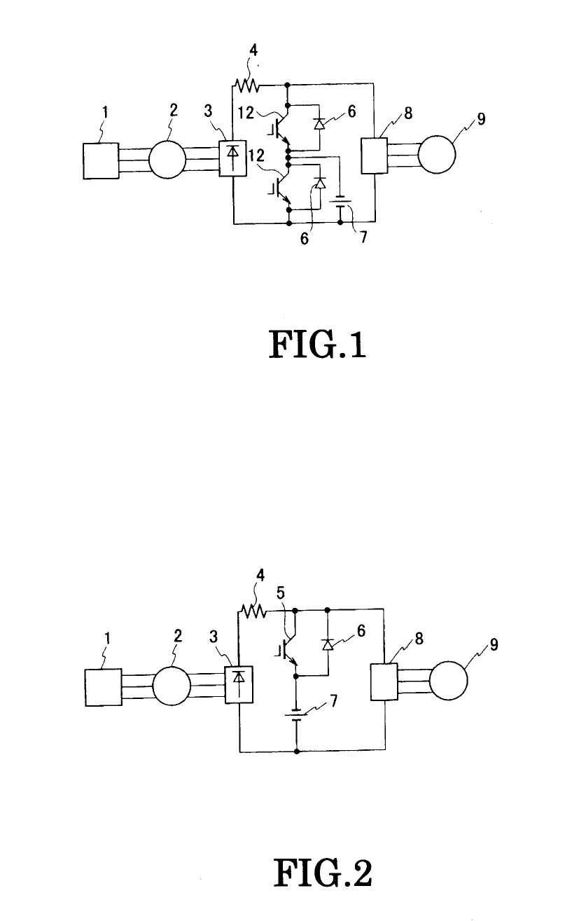

With this embodiment, in the above construction, the conventional storage circuit constituted by the electric storage device 7 and/or voltage boosting chopper device 12 and freewheeling diode 6 shown in FIG. 1 is simplified, making it possible to provide a system of reduced size.

### Second Embodiment

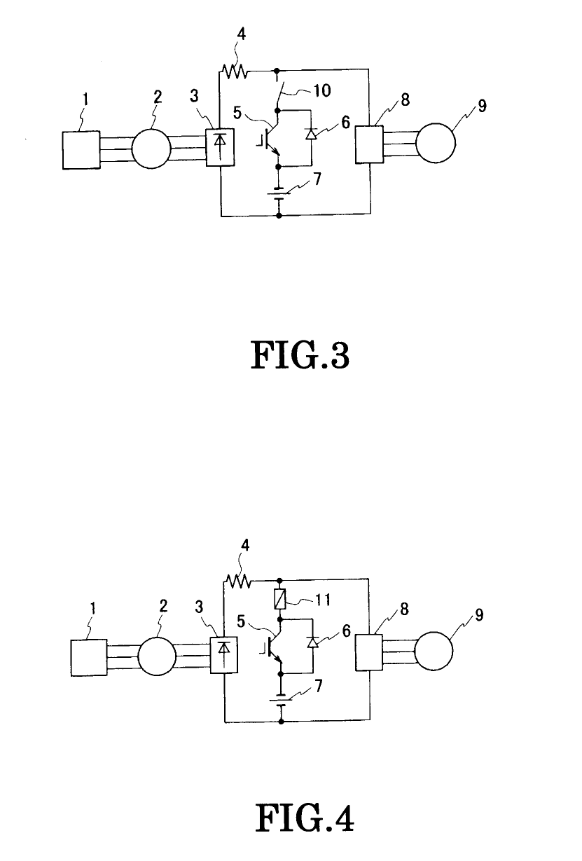

FIG. 3 shows the construction of an electric vehicle control apparatus according to a second embodiment of the present invention.

In the electric vehicle control apparatus according to this embodiment, with respect to the electric vehicle control apparatus of the first embodiment described above, a switch 10 or contacts is provided as a power cut-off device for isolating the main power source (i.e. the internal combustion engine 1 or generator 2 and rectifier 3) and the power conversion device 8.

In the electric vehicle control apparatus of this embodiment, in a condition in which a fault occurs in the power conversion device 8, the power cut-off device constituted by the switch 10 or contacts that is connected with the chopper device 5 and freewheeling diode 6 is opened, thereby cutting off inflow of large current to the chopper device 5 or electric storage device 7.

In this way, in the electric vehicle control apparatus of this embodiment, inflow of large current to the chopper device 5 or electric storage device 7 can be cut off, even in a condition in which a fault of the power conversion device 8 has occurred: consequential damage of the electric storage device 7 can thus be prevented. Also, even in a condition in which power can no longer be supplied to the power conversion device 8 due to occurrence of a short-circuit of the electric storage device 7, the motor 9 can still be driven by supply of driving power from the generator 2, making it possible to continue operation of the electric vehicle.

Thus, the conventional storage circuit constituted by the electric storage device 7 and/or voltage boosting chopper device 12 and freewheeling diode 6 shown in FIG. 1 can thereby be simplified, making it possible to reduce the size of the system.

### Third Embodiment

FIG. 4 shows the construction of an electric vehicle control apparatus according to a third embodiment of the present invention.

In the electric vehicle control apparatus according to this embodiment, in the electric vehicle control apparatus according to the second embodiment described above, as the means for isolating the main power source (i.e. the internal combustion engine 1 and/or generator 2 and rectifier 3) and the power conversion device 8, a fuse 11 is provided instead of the switch 10.

With this embodiment, by the above construction, even in a condition in which a fault occurs in the power conversion device 8, the large current is rapidly cut off by melting of the fuse 11 connected with the chopper device 5 and freewheeling diode 6, thereby making it possible to instantaneously prevent consequential damage to the electric storage device 7. Also, even in a condition in which short-circuiting of the electric storage device 7 has occurred, operation of the vehicle can be continued by supply of working power from the generator 2.

Consequently, in this way, the conventional storage circuitry comprising an electric storage device 7 and/or voltage boosting chopper device 12 and freewheeling diode 6 shown in FIG. 1 can be simplified and a system of smaller size can thus be provided.

### Fourth Embodiment

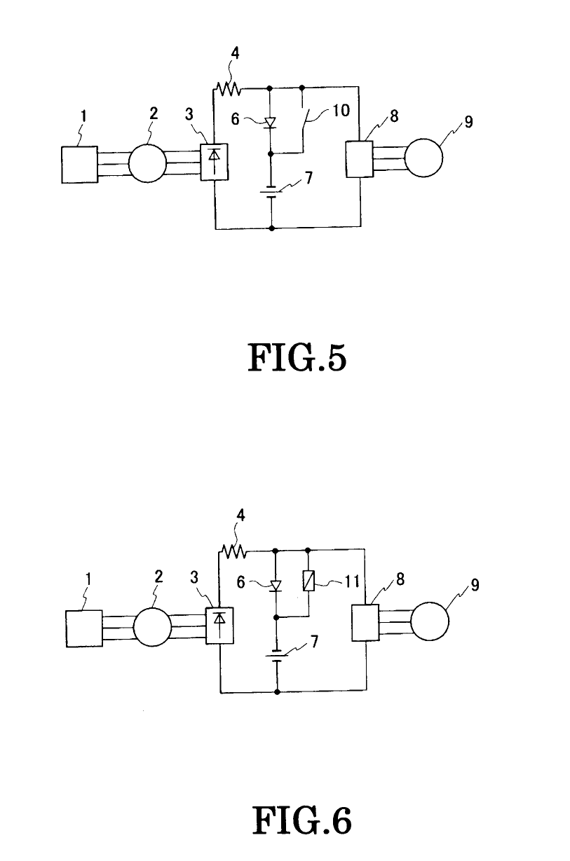

FIG. 5 shows the construction of an electric vehicle control apparatus according to a fourth embodiment of the present invention.

In the electric vehicle control apparatus of this embodiment, in the electric vehicle control apparatus of the first embodiment described above, instead of the parallel circuit of the chopper device 5 and freewheeling diode 6, there is provided a parallel circuit of a freewheeling diode 6 and switch 10 or contacts; this parallel circuit is connected in series with the electric storage device 7.

In the electric vehicle control apparatus of this embodiment, with the above construction, even in a condition in which a short-circuiting fault occurs in the power conversion device 8, the large current is rapidly cut off by opening of the switch 10 or contacts connected with the electric storage device 7.

In this way, even in a condition in which a fault has occurred in the power conversion device 8, with the electric vehicle control apparatus according to this embodiment, consequential damage to the electric storage device 7 can be prevented. Also, even in a condition in which a fault has occurred in the power conversion device 8, charging of the electric storage device 7 is continued through the freewheeling diode 6, and vehicle operation can be continued by supply of working power from the generator 2.

Consequently, in this way, the conventional storage circuitry comprising an electric storage device 7 and/or voltage boosting chopper device 12 and freewheeling diode 6 can be simplified and a system of smaller size can thus be provided.

### Fifth Embodiment

FIG. 6 shows the construction of an electric vehicle control apparatus according to a fifth embodiment of the present invention.

In the electric vehicle control apparatus of this embodiment, in the electric vehicle control apparatus of the fourth embodiment described above, a fuse 11 is provided instead of the switch 10 or contacts.

With the electric vehicle control apparatus of this embodiment, in the above construction, even in the event of a condition in which a short-circuiting fault of the power conversion device 8 has occurred, the large current is rapidly cut off by melting of the fuse 11 that is connected with the electric storage device 7.

In this way, even in a condition in which a fault has occurred in the power conversion device 8, with the electric vehicle control apparatus of this embodiment, consequential damage to the electric storage device 7 can be instantaneously prevented. Also, an electric vehicle control apparatus can be provided wherein, even in a condition in which a fault has occurred in the power conversion device 8, charging of the electric storage device 7 is continued through the freewheeling diode 6, and vehicle operation can be continued by supply of working power (driving power) from the generator 2. Also, the conventional storage circuitry comprising an electric storage device 7 and/or voltage boosting chopper device 12 and freewheeling diode 6 can be simplified and a system of smaller size can thus be provided.

Field of Industrial Application

With the present invention, the conventional storage circuitry comprising for example an electric storage device and/or voltage boosting chopper device and freewheeling diode can be simplified and a system of smaller size can thus be provided.

With the present invention, even in a condition in which a fault has occurred in the power conversion device, consequential damage to the electric storage device can be prevented by the current cut-off device and at the same time charging of the power of accumulation device can be continued through the freewheeling diode; also, vehicle operation can be continued by supply of working power (driving power) from the power source.

1. An electric vehicle control apparatus comprising:
a power source that supplies DC power;
a power conversion device that converts said DC power from said power source to AC power, which said power conversion device then supplies to a vehicle drive motor;
an electric storage device for accumulating DC power arranged in parallel between said power source and power conversion device;
a chopper device that is connected in series with said electric storage device, and that supplies power to said electric storage device by chopping said DC power from said power source and a regenerated DC power from said power conversion device; and
a freewheeling diode for passing current in a direction such as to supply current from said electric storage device to said power conversion device, connected in series with said electric storage device and in parallel with said chopper device.

2. The electric vehicle control apparatus according to claim 1,
wherein said electric storage device is an electrical double-layer capacitor.

3. The electric vehicle control apparatus according to claim 1,
wherein a current cut-off device comprising a switch is provided in series with a parallel circuit of said chopper device and freewheeling diode.

4. The electric vehicle control apparatus according to claim 1,
wherein a current cut-off device comprising contacts is provided in series with a parallel circuit of said chopper device and freewheeling diode.

5. The electric vehicle control apparatus according to claim 1,
wherein a current cut-off device comprising a fuse is provided in series with a parallel circuit of said chopper device and freewheeling diode.

6. An electric vehicle control apparatus comprising:
a power source that supplies DC power;
a power conversion device that converts said DC power from said power source to AC power, which said power conversion device then supplies to a vehicle drive motor;
an electric storage device for accumulating DC power arranged in parallel between said power source and power conversion device;
a freewheeling diode for passing current in a direction such as to supply current from said power source to said electric storage device, connected in series with said electric storage device; and
a current cut-off device connected in series with said electric storage device and connected in parallel with said freewheeling diode.

7. The electric vehicle control apparatus according to claim 6,
wherein said electric storage device is an electrical double-layer capacitor.

8. The electric vehicle control apparatus according to claim 6,
wherein said current cut-off device is a switch.

9. The electric vehicle control apparatus according to claim 6,
wherein said current cut-off device is contacts.

10. An electric vehicle control apparatus comprising:
a power source that supplies DC power;
a power conversion device that converts said DC power from said power source to AC power, which said power conversion device then supplies to a vehicle drive motor;
an electric storage device for accumulating DC power arranged in parallel between said power source and power conversion device;
a freewheeling diode for passing current in a direction such as to supply current from said power source to said electric storage device, connected in series with said electric storage device; and
a current cut-off device comprising a fuse connected in series with said electric storage device and connected in parallel with said freewheeling diode.
